(19) United States
(12) Patent Application Publication
(10) Pub. No.: US 2011/0047718 A1
(43) Pub. Date: Mar. 3, 2011

(54) Dyeable Polyester Fibers, Methods for Preparing the Same and Applications Thereof

(75) Inventors: Shih-Hsiung Chen, Zhongli City (TW); Pang-Chin Liu, Zhongli City (TW)

(73) Assignee: FAR EASTERN NEW CENTURY CORPORATION, Taipei City (TW)

(21) Appl. No.: 12/859,326

(22) Filed: Aug. 19, 2010

(30) Foreign Application Priority Data
Aug. 26, 2009 (TW) 98128699

(51) Int. Cl. D06M 23/00; C08G 63/00; D06P 7/00

(52) U.S. Cl. 8/494; 525/437; 8/497

(57) ABSTRACT

A method for dyeing a modified polyester fiber is provided. A polyester composition is melt blended with a modifying agent to form a thermoplastic composition. The modifying agent is an aliphatic-aromatic co-polyester, and present in an amount of about 1 to 16 parts by weight per 100 parts by weight of the thermoplastic composition. The thermoplastic composition is melt spun to obtain the modified polyester fiber, and the modified polyester fiber is dyed with a disperse dye at a temperature between about 100° C. and about 130° C.

### RELATED APPLICATIONS

This application claims priority to Taiwan Application Serial Number 98128699, filed Aug. 26, 2009, which is herein incorporated by reference.

### BACKGROUND

1. Field of Invention

Embodiments of the present invention generally relate to a dyeable polyester fiber; more particularly, to a polyester fiber dyeable in a lower temperature.

2. Description of Related Art

Polyester fibers are the fibers made by condensation polymerization of di-ols and aromatic di-acids. Examples of polyester fibers include, but are not limited to, polyethylene terephthalate (PET), polybutylene terephthalate (PBT), polytrimethylene terephthalate (PTT), poly-1,4-cyclohexane dimethylene terephthalate (PCT), and poly(ethylene 2,6-naphthalate) (PEN) fibers.

Among those fibers, the PET fibers are most famous for having satisfactory thermal stability, elasticity, and endurance. Nowadays, PET fibers are widely used for the manufacture of clothing, bedding products, and house furnichings.

It is known that polyester fibers have high crystallinity, and hence, polyester fibers should be dyed at a relatively higher pressure and higher temperature (usually greater than 130° C.) so as to attain an ideal dyeing result. The high pressure and high temperature process increase the complexity and capital cost of the manufacturing process.

Besides, polyester fiber may be blend weaved with other kinds of fibers to obtain blended fabrics (or mixture fabrics) having various properties and/or different hand feelings. However, it is known that fibers such as wool, cellulose acetate, and nylon are intolerant to the high-temperature (>130° C.) dyeing process, and when the polyester fibers are blend weaved with such fibers, the dyeing process of the resultant blended fabrics is troublesome. To retain the physical properties of the resultant blended fabrics, one may dye such blended fabrics at a temperature lower than 130° C.; however, the dyeing uniformity and fastness of the blended fabrics may be unsatisfactory. On the contrary, one may dye the resultant blended fabrics at a temperature of at least 130° C. to obtain a satisfactory uniformity and fastness; yet, in this case, the high-temperature intolerant fibers of the blended fabrics may be deteriorated thereby jeopardizing the appearance and hand feel of the blended fabrics.

Hence, it is desired to lower the dyeing temperature for polyester fiber so as to enhance the dyeing performance of such blended fabrics. One conventional approach for lowering the dyeing temperature of the polyester fiber is to chemically modify the polyester compositions for spinning fiber by adding modifying monomers during the esterification-polymerization process. Known modifying monomers may be categorized into di-acid monomers and di-ol monomers.

Prior references disclosing di-acid monomers suitable for used as a modifying monomer include: CN 1370858A (1-15 mol % of aliphatic dicarboxylic acid); CN 1175023C (phthalic acid); and CN 1282775C (aromatic dicarboxylic acid with sulfonic acid group and lamellae silicate). Besides, U.S. 2007/0055043 discloses that a polyether polyol having multiple hydroxyl groups, in addition to an aliphatic di-acid, can be added during the co-polymerization.

Prior references disclosing di-ol monomers suitable for used as a modifying monomer include: CN1283690C (polyoxyalkylene glycol and 1,3-propylene glycol); U.S. Pat. No. 5,916,677 (2-methyl-1,3-propanediol); and U.S. Pat. No. 6,998,461 (alkoxylated 2-methyl-1,3-propanediol).

By preparing polyester compositions according to the method described hereinabove, the polyester fibers spun therefrom may have a dyeing temperature lower than 130° C. However, the properties of the polyester compositions may not be readily controlled. Besides, the polyester composition is only suitable for prepare fibers with some particular specifications. As such, such polyester compositions are not suitable for commercial mass-production.

Another conventional method for lowering the dyeing temperature of the polyester fiber involves in using a low-temperature-dyeable polyester to modify the polyester composition. For example, U.S. Pat. No. 6,187,900 and U.S. Pat. No. 6,218,008 teach to melt blend polytrimethylene terephthalate (PTT) and polyethylene terephthalate (PET) to obtain a PTT/PET co-polyester. The dyeing temperature of PTT is about 110° C., and hence, the PTT/PET co-polyester and fibers spun therefrom may have a dyeing temperature between about 110° C. to about 130° C., depending on the weight ratio between PTT and PET. However, such improvement is not satisfactory for many commercial applications.

In view of the foregoing, there exists in this art a need to provide a modified polyester composition suitable for preparing a modified polyester fiber with a lower dyeing temperature, wherein the modified polyester composition and/or fiber are prepared by a simple process compatible with conventional manufacturing methods and equipments. Also, such modified polyester composition is suitable for preparing fibers of various conventional specifications. As such, the manufacturing cost for preparing such modified polyester fiber may be reduced, and the commercial applicability of such modified polyester fiber may be enhanced. Moreover, the modified polyester fiber may be blend weaved with various fibers to obtain blended fabrics with higher added values.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present invention is directed to a method for dyeing a modified polyester fiber. According to the method provided herein, a dyeable modified polyester fiber can be dyed at a dying temperature of about 100-130° C., which is lower than the conventional ones (usually no less than 130° C.). Also, the modified polyester fiber has a deep dyeing capability. Besides, the modified polyester fiber exhibits a satisfactory washing fastness after dyeing.

According to one embodiment of the present invention, the method comprises the steps as follows. First, a polyester composition is provided. The polyester composition is a reaction product of an aromatic dicarboxylic acid and an aliphatic di-ol. A modifying agent is then melt blended with the polyester composition to form a thermoplastic composition. In 100 parts by weight of the thermoplastic composition, the modifying agent is present in an amount ranging from about 1 to 16 parts by weight. The modifying agent is a aliphatic-aromatic co-polyester and has a structure represented by the following general formula (1):

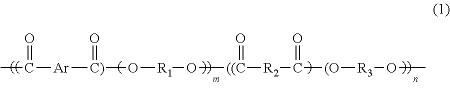

where Ar is a C₆₋C₂₀ aromatic group, each of R₁, R₂ and R₃ is independently a C₂-C₂₀ alkane, each of R₁, R₂ and R₃ may be same or different, 50≦m≦400, 60≦n≦160, and the m/n ratio is a value between about 0.9 and 2.5. Thereafter, the thermoplastic composition is melt spun to form the modified polyester fiber. The as-spun modified polyester fiber is then dyed with a disperse dye at a dyeing temperature ranging from about 100 to 130° C.

In another aspect, the present invention is directed to a method for dyeing a blended fabric. According to the method provided herein, a blended fabric can be dyed at a dying temperature of about 100-130° C. Generally, the blended fabric provided herein comprises a modified polyester fiber as briefly described hereinabove and a fiber that cannot tolerate a temperature higher than 130° C. As such, the method disclosed herein is suitable for both maintaining the respective physical properties of the constituent fibers and achieving satisfactory dyeing performances and washing fastness of the blended fabric.

According to one embodiment of the present invention, the method comprises the steps as follows. First, a polyester composition is provided. The polyester composition is a reaction product of an aromatic dicarboxylic acid and an aliphatic di-ol. A modifying agent is then melt blended with the polyester composition to form a thermoplastic composition. In 100 parts by weight of the thermoplastic composition, the modifying agent is present in an amount ranging from about 1 to 16 parts by weight. The modifying agent is a aliphatic-aromatic co-polyester and has a structure represented by the following general formula (1):

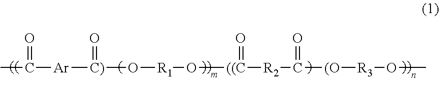

where Ar is a C₆-C₂₀ aromatic group, each of R₁, R₂ and R₃ is independently a C₂-C₂₀ alkane, each of R₁, R₂ and R₃ may be same or different, 50≦m≦400, 60≦n≦160, and the m/n ratio is a value between about 0.9 and 2.5. Thereafter, the thermoplastic composition is melt spun to form the modified polyester fiber. The as-spun modified polyester fiber is then blend weaved with a fiber that does not tolerate a temperature higher than 130° C. to obtain the blended fabric. Afterwards, the blended fabric is dyed with a disperse dye at a temperature between about 100° C. and about 130° C.

In yet another aspect, the present invention is directed to a low-temperature dyeable polyester fiber produced from a thermoplastic composition. The low-temperature dyeable polyester fiber may be preferably dyed in accordance with the method of the above-described aspect/embodiment of the present invention. The low-temperature dyeable polyester fiber provided by the embodiments of present invention can be dyed easily at a temperature under 130° C., even as low as 100° C., and still exhibits a deep dyeing capability and satisfactory washing fastness after dyeing.

According to one embodiment of the present invention, the low-temperature dyeable polyester fiber is produced from a thermoplastic composition comprising polypropylene terephthalate and a modifying agent. In 100 parts by weight of the thermoplastic composition, the modifying agent is present in an amount ranging from about 1 to 16 parts by weight. The modifying agent is a aliphatic-aromatic co-polyester and has a structure represented by the following general formula (1):

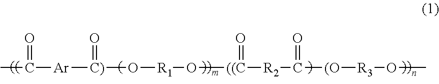

where Ar is a C₆-C₂₀ aromatic group, each of R₁, R₂ and R₃ is independently a C₂-C₂₀ alkane, each of R₁, R₂ and R₃ may be same or different, 50≦m≦400, 60≦n≦160, and the m/n ratio is a value between about 0.9 and 2.5. Thereafter, the thermoplastic composition is melt spun to form the low-temperature dyeable polyester fiber.

It is to be understood that both the foregoing general description and the following detailed description are by examples, and are intended to provide further explanation of the invention as claimed.

### DETAILED DESCRIPTION

As discussed hereinabove, conventional polyester fibers are highly crystalline, and hence, the dyeing processes of such polyester fibers are usually carried out at a temperature higher than 130° C. Despite prior attempts to lower the dyeing temperature of polyester, they were unable to provide polyester fibers with satisfactory properties required for commercial applications.

In view of the foregoing, the present invention addresses such problem(s) by providing a method for dyeing a polyester fiber at a dyeing temperature no greater than about 130° C., and a dyeable polyester fiber suitable for use in the above-mentioned dyeing process.

Briefly, the dyeable polyester fiber is made from a thermoplastic composition. In the context of the present application, the thermoplastic composition is a ,modifed polyester composition including a polyester and a modifier (also referred to as a modifying agent in the present application).

According to one embodiment of the present invention, the method for dyeing a modified polyester fiber comprises the following steps:

(a) Providing a polyester composition; (b) Melt blending a modifying agent with the polyester composition to form a thermoplastic composition;

(c) Melt spinning thermoplastic composition to form the modified polyester fiber; and (d) Dyeing the as-spun modified polyester fiber with a disperse dye at a dyeing temperature ranging from about 100 to 130° C.

According to the principles and spirits of the present invention, the polyester composition is a reaction product of aromatic dicarboxylic acid and aliphatic di-ol. Illustrative examples of the polyester composition include, but are not limited to, polyethylene terephthalate (PET), polybutylene terephthalate (PBT), and polytrimethylene terephthalate (PTT). In one example, the polyester is PET.

The modifier is an aliphatic-aromatic co-polyester having the structure of:

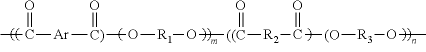

where Ar is a C₆-C₂₀ aromatic group, each of R₁, R₂ and R₃ is independently a C₂-C₂₀ alkane, each of R₁, R₂ and R₃ may be same or different, 50≦m≦400, 60≦n≦160, and the m/n ratio is a value between 0.9-2.5. In one embodiment, 80≦m≦280 and 70≦n≦150, and the m/n ratio is a value between 1-2. Besides, the aliphatic-aromatic co-polyester has an average molecular weight (Mn) between about 30,000-60,000 Da.

In one embodiment, the modifier is in an amount of about 1-16 wt % of the thermoplastic composition. Preferably, the modifying agent is in an amount of about 3-12 wt % of the thermoplastic composition. For example, the amount of the modifying agent may range from about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, or 16 parts by weight per 100 parts by weight of the thermoplastic composition.

In one embodiment, the modifying agent has a melting point ranges from about 100° C. to about 200° C. Preferably, the modifying agent has a melting point ranges from about 120° C. to about 180° C. More preferably, the modifying agent has a melting point ranges from about 130° C. to about 170° C. Still more preferably, the modifying agent has a melting point ranges from about 140° C. to about 160° C. For example, in the working examples presented hereinbelow, the melting points of the modifying agents are about 140, 150 or 160° C., respectively.

According to the principle and spirit of the present invention, the aliphatic-aromatic co-polyester is made by reacting at least two dicarboxylic acids and a di-ol. The two dicarboxylic acid may be an aliphatic dicarboxylic acid and an aromatic dicarboxylic acid, respectively, and the di-ol is an aliphatic di-ol.

Examples of the aliphatic dicarboxylic acid include, but are not limited to, malonic acid, succinic acid, glutaric acid, adipic acid, pimelic acid, suberic acid, azelaic acid, sebacic acid, maleic acid, fumaric acid, 2,2-dimethyl glutaric acid, 1,3-cyclopantane dicarboxylic acid, 1,4-cyclopantane dicarboxylic acid, 1,3-cyclohexane dicarboxylic acid, diglycolic acid, itaconic acid, and 2,5-norbornane dicarboxylic acid.

Examples of the aromatic dicarboxylic acid include, but are not limited to, terephthalic acid, phthalic acid, 2,6-naphthalene dicarboxylic acid, and 1,5-naphthalene dicarboxylic acid.

Examples of the aliphatic di-ol include, but are not limited to, ethylene glycol, 1,2- propylene glycol, 1,3- propylene glycol, diethylene glycol, 2,2-dimethyl-1,3- propylene glycol, 1,3-butylene glycol, 1,4-butylene glycol, 1,5-pentylene glycol, 1,6- hexylene glycol, 2,2,4-trimethyl-1,6-hexylene glycol, 1,3-cyclohexanedimethanol, and 1,4- cyclohexanedimethanol.

The thermoplastic composition is subject to a melt spinning process to produce modified polyester fibers. The parameters of the melt spinning process are well known to those with ordinary skill in the art, and can be easily determined based on the material used and the product desired. Hence, the melt spinning process is not elaborated in detail for the sake of brevity.

Afterward, the as-spun modified polyester fiber is dyed with a disperse dye at a dyeing temperature ranging from about 100 to 130° C. Alternatively, the as-spun modified polyester fiber is manufactured to obtain a fabric or textile, and then the fabric/textile is dyed with a disperse dye at a dyeing temperature ranging from about 100 to 130° C. For example, the dyeing temperature may be about 100, 105, 110, 115, 120, 125, or 130° C.

In one embodiment of the present invention, the disperse dye used for dyeing the modified polyester fiber may be a blue disperse dye, but the present invention is not limited thereto. Illustrative examples of other disperse dye include, but are not limited to orange disperse dye, violet disperse dye, red disperse dye, and black disperse dye.

Generally, the modified polyester fibers disclosed herein can be categorized into long fibers and short staples. The long fibers may be made into partially-oriented yarns and false twisted filaments, whereas the short staples may be made into undrawn yarns by conventional procedure.

The cross sectional shape of the modified polyester fiber is not limiting, for example, it may be circle, oval, three-lobe, triangle, T-bone, or shoulder-flat in shape. Alternatively, the modified polyester fiber may be a hollow fiber having a suitable cross sectional shape.

In another aspect, the present invention is directed to a method for dyeing a blended fabric. According to the principles and spirits of the present invention, the blended fabric provided herein comprises a modified polyester fiber according to the above-mentioned aspect/embodiment(s) of the present invention and a fiber that cannot tolerate a temperature higher than 130° C.

According to one embodiment of the present invention, the method comprises the steps as follows. First, steps (a), (b) and (c) as described hereinabove is carried out to obtain a modified polyester fiber. Then, the as-spun modified polyester fiber is then blend weaved with a fiber that does not tolerate a temperature higher than 130° C. to obtain the blended fabric. Afterwards, the blended fabric is dyed with a disperse dye at a temperature between about 100° C. and about 130° C.

It should be noted that the description regarding various examples and embodiments of steps (a)-(c) and the dyeing condition(s), as provided in the previous aspect, are equally applicable here. Accordingly, for the sake of brevity and clarity, descriptions regarding these process steps are not repeated hereinbelow.

According to the principles and spirits of the present invention, any artificial and/or nature fibers that cannot tolerate a temperature higher than 130° C. can be used to blend weaved with the modified polyester fiber provided herein. Illustrative examples of such fibers include, but are not limited to: cotton, wool, linen, silk and nylon.

Since each fiber may have different unique physical properties, such as elasticity, flexibility, strength, smoothness, stiffness, air permeability, etc, the fibers may endow additional properties to the resultant blended fabrics. As discussed hereinabove, due to their less heat-resistant nature, it is not commercially feasible to blend weave such fibers with conventional polyester fibers to obtain blended fabrics, since such blended fabrics cannot withstand the high dyeing temperature (no less than 130° C.) of the subsequent dying process.

However, according to the method provided herein, the blended fabrics can be dyed at a temperature between about 100° C. to about 130° C. As such, various high quality textiles with added values may be developed by blend weaving the modified polyester fiber provided herein with a wide range of fibers that cannot tolerate the temperature of about 130° C.

The working examples of present invention and the test results are disclosed below. Although the present invention has been described in considerable detail with reference to certain embodiments thereof, other embodiments are possible. Therefore, their spirit and scope of the appended claims should not be limited to the description of the embodiment container herein.

The polyester utilized in the working examples of present invention was polyethylene terephthalate (PET), such as A-17 and CSS-910 (Far Eastern New century corporation, Taiwan, R.O.C.). A-17 and CSS-910 were used to manufacture long fibers and short staples, respectively. These two polyesters, A-17 and CSS-910, have identical monomer structure and equal melting point (254° C.).

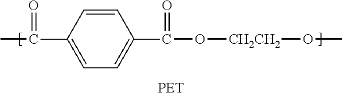

In one embodiment, three kinds of modifying agents (e.g., co-polyesters) are used, they are FEPOL®2040, FEP-150, and FEP-160 (Far Eastern Textile

Ltd, Taiwan, R.O.C.), respectively. The co-polyesters are reaction products of acids such as adipic acid or terephthalic acid and diols such as 1,4-butanediol, each co-polyester has a characteristic melting point of its own. The characteristics and structures of these three co-polyesters are summarized below.

| Modifying agent | Mn (Da) | m | n | m/n | Tₘ (° C.) | Structure |
|---|---|---|---|---|---|---|
| FEPOL•2040 | 41.488 | 110 | 85 | 1.3 | 140 | 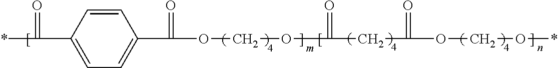 |
| FEP-150 | 54.072 | 245 | 155 | 1.58 | 150 | 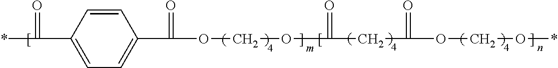 |
| FEP-160 | 59.413 | 270 | 138 | 1.95 | 160 | 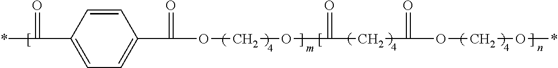 |

In one embodiment, the dye is a blue disperse dye, Dianix Navy XF, which is available from Dystar Ltd.

In one embodiment, hue whiteness (L value) is used as an index to determine the capability of a fiber whether it may be deeply dyed or not. The L value decreases as the color becomes darker. The fineness, strength, and elongation properties of the fibers are measured by using of a mechanical property test instrument (CNS L4060). In one embodiment, washing fastness and sunlight fastness of a fiber are determined in accordance with protocols ISO 105-C06 and ISO 105-B02, respectively. According to the international commercial agreement, the color fastness of a fiber after washing fastness and sunlight fastness tests may not be lower than level 3 (in level 1-5, level 1 is the poorest and level 5 is the best). After dyeing, the background reflectivity (R %) was measured by a spectrometer (model CS-5 Chroma-Sensor) and relative color fastness (K/S) is located from the table. The relative color fastness (K/S) is calculated by the following equation.

$$Relative dyeing fastness ( \% ) = \frac{K \text{/} S ( dyed sample textile )}{K \text{/} S ( dyed standard textile )} \times 100 \%$$

The sample textile may be the filament with or without a modifying agent. The standard textile is the filament without a modifying agent. The relative color fastness increases as the color becomes darker.

### EXAMPLE 1

Melting and mixing 97 wt % PET polyester (A-17) (2910 g) and 3 wt % modifying agent (FEPOL®2040) (90 g) by conventional process and thereby producing modified polyester mixture grain. The modified polyester mixture grain was then dyed with a blue disperse dye for 40 minutes at 100° C. The measured hue whiteness (L) of the sample was 19.5.

### EXAMPLE A2

The operating condition was generally the same as example A1 except for the concentration of A-17 and modifying agent (FEPOL® 2040), which were 95 wt % (2850 g) and 5 wt % (150 g), respectively. After dying, the measured hue whiteness (L) of the modified polyester mixture grain sample was 18.9.

### EXAMPLE A3

The operating condition was generally the same as example A1 except for the concentration of A-17 and modifying agent (FEPOL® 2040), which were 93 wt % (2790 g) and 7 wt % (210 g), respectively. After dying, the measured hue whiteness (L) of the modified polyester mixture grain sample was 19.0.

### EXAMPLE A4

The operating condition was generally the same as example A1 except for the concentration of A-17 and modifying agent (FEPOL® 2040), which were 91 wt % (2730 g) and 9 wt % (270 g), respectively. After dying, the measured hue whiteness (L) of the modified polyester mixture grain sample was 19.2.

### EXAMPLE A5

The operating condition was generally the same as example A1 except for the concentration of A-17 and modifying agent (FEPOL® 2040), which were 89 wt % (2670 g) and 11 wt % (330 g), respectively. After dying, the measured hue whiteness (L) of the modified polyester mixture grain sample was 19.2.

### EXAMPLE B1 (COMPARATIVE)

The operating condition was generally the same as example A1 except for the concentration of A-17, which was 100 wt % (3000 g). After dying, the measured hue whiteness (L) of the modified polyester mixture grain sample was 24.2.

In summary, the hue whiteness (L) of the modified polyester was lower than that of the unmodified polyester. Data is shown in Table 1. The result indicated that the color of the dyed modified polyester was darker at 100° C., and L decreased as the amount of modifying agent increased, such result confirmed the observation that the modifying agent co-polyester is capable of improving the deep dyeing capability of the fibers.

TABLE 1

| Exam- | Poly- | | Modifying | | Dyeing tem- | L |
|---|---|---|---|---|---|---|
| ple | ester | wt % | agent | wt % | perature(° C.) | value |
| A1 | PET | 97 | FEPOL · 2040 | 3 | 100 | 19.5 |
| A2 | (A-17) | 95 | | 5 | 100 | 18.9 |
| A3 | | 93 | | 7 | 100 | 19.0 |
| A4 | | 91 | | 9 | 100 | 19.2 |
| A5 | | 89 | | 11 | 100 | 19.2 |
| B1 | | 100 | | 0 | 100 | 24.2 |

### EXAMPLE C1

Melting and mixing 95 wt % PET polyester (A-17) (2850 g) and 5 wt % modifying agent (FEPOL®2040) (150 g) by conventional process and thereby producing modified polyester mixture grains. The modified polyester mixture grains were then dyed with the blue disperse dye for 40 minutes at 100° C. The hue whiteness (L) of the sample was 19.3.

### EXAMPLE C2

The operating condition was generally the same as example C1 except the modifying agent FEP-150 was used instead. After dying, the hue whiteness (L) of the modified polyester sample was 19.3.

### EXAMPLE C3

The operating condition was generally the same as example C1 except the modifying agent FEP-160 was used instead. After dying, the hue whiteness (L) of the modified polyester sample was 19.5.

### EXAMPLE D1 (COMPARATIVE EXAMPLE)

The operating condition was generally the same as example B1 except for the concentration of A-17, which was 100 wt % (3000 g). After dying, the hue whiteness (L) of the modified polyester sample was 20.2.

In summary, the hue whiteness (L) of the modified polyester was lower than that of the unmodified polyester. These three categories of modified polyester do not differ significantly in hue whiteness (h). Accordingly, the color of the modified polyesters was darker, and the modified polyesters could be dyed at a relatively lower temperature (100° C.). The data is shown in Table 2.

TABLE 2

| Exam- | Poly- | | Modifying | | Dyeing tem- | L |
|---|---|---|---|---|---|---|
| ple | ester | wt % | agent | wt % | perature(° C.) | value |
| C1 | PET | 95 | FEPOL · 2040 | 5 | 100 | 19.3 |
| C2 | (A-17) | 95 | FEP-150 | 5 | 100 | 19.3 |
| C3 | | 95 | FEP-160 | 5 | 100 | 19.5 |
| D4 | | 100 | — | 0 | 100 | 20.2 |

### EXAMPLE E

The polyester in example A5 (made by 89 wt % A-17and 11 wt % FEPOL®2040) was re-processed into a partially-oriented yarn by conventional melting spinning method. The samples were made into the yarn that is ready to be spun by conventional false twisting process. The mechanical properties of the partially-oriented yarn and the false twisted yarn were then measured, respectively. The fineness, strength, and elongation property of the partially-oriented yarn were 125 den, 2.0 g/d and 138%, respectively, and each sample has normal appearance. The fineness, strength, and elongation property of the false twisted yarn were 76.7 den, 3.4 g/d and 19.3%, respectively, and each sample appearance has normal appearance.

### EXAMPLE F (COMPARATIVE)

The operating condition was generally the same as example E except for the concentration of A-17, which was 100 wt %. The fineness, strength, and elongation property of the partially-oriented yarn were 125 den, 2.6 g/d and 140%, respectively, and each sample has a normal appearance. The fineness, strength, and elongation property of the false twisted yarn were 75.0 den, 4.2 g/d and 21.0%, respectively, and each sample has a normal appearance.

In summary, if the fineness were equal, the partially-oriented yarn made by modified polyester or normal polyester had almost the same fiber strength and elongation property. Results indicated that there is no significant difference between the mechanical properties of the modified polyester and normal polyester. The normal appearances of the fibers indicated that the modified polyester could be manufactured into partially-oriented yarn by conventional method. Additionally, the false twisted yarn made by modified polyester or normal polyester had almost the same mechanical properties except the false twisted yarn produced from the modified polyester had lower fiber strength. The appearance of the false twisted yarn produced form either modified polyester or normal polyester was similar. Accordingly, the false twisted property of the modified polyester is acceptable.

### EXAMPLE G1

The false twisted yarns of modified polyester in example E (made by 89 wt % PET polyester A-17 and 11 wt % modifying agent FEPOL®2040) was made into garters according to known methods. The garters were dyed with the blue disperse dye for 40 minute at the temperature of 100° C. The bath ratio (e.g. the volume ratio of the garters and water) was about 1:15. After dyeing, the color and the relative color strength of the garters were measured, respectively. The hue whiteness (L) and relative color strength were 25.6 and 226, respectively. Next, the dyed garters were washed using 70° C. water for 15 minutes. Then, a heat treatment at the temperature of 130° C. was applied for 1.5 minutes. Finally, the washing fastness of the garters was determined in accordance with the protocol, ISO 105-C06.

To test the washing fastness, various filament samples were stitched on the modified polyester textile, such as normal polyester, nylon, and cotton. After the test, the color fastness of the filament samples stitched on the modified polyester textile was determined by a standard color fastness instrument to see if the dye of the modified polyester textile would come off or being transferred to the filament sample. In sunlight fastness test, the dyed garters were irradiated with a sun-like light source in accordance with the protocol, ISO 105-B02, and the color fastness was determined by the standard color fastness instrument. The washing fastness level of each of the normal polyester, nylon, and cotton was 4.5, whereas the sunlight fastness level of the modified polyester was 4.0.

### EXAMPLE G2

The operating condition was generally the same as example G1 except for the dyeing temperature, which was 110° C. The hue whiteness (L) and the relative color strength were 25.2 and 111, respectively. The washing fastness level of each of the normal polyester, nylon, and cotton was 4.5, whereas the sunlight fastness level of the modified polyester was 4.0.

### EXAMPLE G3

The operating condition was generally the same as example G1 except for the dyeing temperature, which was 120° C. The hue whiteness (L) and the relative color strength were 24.7 and 104, respectively. The washing fastness level of each of the normal polyester, nylon, and cotton was 4.5, whereas the sunlight fastness level of the modified polyester was 4.0.

### EXAMPLE G4

The operating condition was generally the same as example G1 except for the dyeing temperature, which was 130° C. The hue whiteness (L) and the relative color strength were 23.0 and 103, respectively. The washing fastness level of each of the normal polyester, nylon, and cotton was 4.5, whereas the sunlight fastness level of the modified polyester was 4.0.

### EXAMPLE H1 (COMPARATIVE EXAMPLE)

The operating condition was generally the same as example G1 with the dyeing temperature set at 100° C., and the concentration of A-17 was 100 wt %. The measured hue whiteness (L) was 35.1.

### EXAMPLE H2 (COMPARATIVE EXAMPLE)

The operating condition was generally the same as example H1 except for the dyeing temperature, which was set at 110° C. The measured hue whiteness (L) was 26.4.

### EXAMPLE H3 (COMPARATIVE EXAMPLE)

The operating condition was generally the same as example H1 except for the dyeing temperature, which was 120° C. The measured hue whiteness (L) was 25.3.

### EXAMPLE H4 (COMPARATIVE EXAMPLE)

The operating condition was generally the same as example H1 except for the dyeing temperature, which was 130° C. The measured hue whiteness (L) was 23.7 and the relative color strength of this sample was defined as 100.

In summary, the modified PET polyester (A-17) had lower hue whiteness

(L) than unmodified one at the same dyeing temperature, which was lower than 130° C. Additionally, the higher relative color strength of the modified PET polyester (A-17), which was above 100, showed that the dyeing performance of the modified polyester is better than that of the unmodified one (e.g. deeper dyed color) at the same dyeing temperature. Data is shown in Table 3.

TABLE 3

| | Modifying | Dyeing | | |
|---|---|---|---|---|
| | agent | temperature | | Relative color |
| Example | (FEPOL 2040) | (° C.) | L value | strength (%) |
| G1 | with | 100 | 25.6 | 226 |
| G2 | | 110 | 25.2 | 111 |
| G3 | | 120 | 24.7 | 104 |
| G4 | | 130 | 23.0 | 103 |
| H1 | without | 100 | 35.1 | 100 |
| H2 | | 110 | 26.4 | 100 |
| H3 | | 120 | 25.3 | 100 |
| H4 | | 130 | 23.7 | 100 |

The result depicted that the washing fastness of the modified polyester, which was dyed at relatively lower temperature (<130° C.), attains the industry application standard, since the washing fastness of each of the normal polyester, nylon and cotton was above level 4. The result also confirmed that the modified polyester may exhibit relatively higher dyeing strength, and would not fade easily in washing. Additionally, the modified polyester textile also attains level 4 in sunlight fastness test.

### EXAMPLE I

Melting and mixing 90 wt % PET polyester (CSS-910) (180 g) and 10 wt % modifying agent (FEPOL®2040) (20 g) by conventional process and thereby producing modified polyester mixture grains. Then, the grains were made into undrawn yarns by conventional melting spinning method. Next, the undrawn yarns were re-produced to be short staples. The mechanical properties of the undrawn yarns were then measured. The length, fineness, strength and the elongation property of the short staples were 38.9 mm, 1.53 den, 4.7 g/d, and 53.4%, respectively.

### EXAMPLE J (COMPARATIVE EXAMPLE)

The operation condition was generally the same as example I except for the concentration of PET polyester (CSS-910) was 100 wt % (200 g). The length, fineness, strength and the elongation property of the short staples were 39.5 mm, 1.48 den, 5.0 g/d, and 47.2%, respectively.

In summary, the modified PET polyester CSS-910 had the same mechanical properties as the unmodified one, except for the elongation property.

Accordingly, the modified PET polyester CSS-910 could be made into short staples by conventional method.

### EXAMPLE K1

The short staples of the modified polyester in example I (made by 90 wt % PET polyester CSS-910 and 10 wt % modifying agent FEPOL®2040) was made into garters according to known methods. The garters were dyed with the blue disperse dye for 40 minutes at the temperature of about 100° C. The bath ratio (e.g. the volume ratio of the garters and water) was about 1:15. After dying, the color and the relative color strength were measured, respectively. The hue whiteness (L) and relative color strength were 19.8 and 112, respectively. Next, the dyed garters were washed using 70° C. water for 15 minutes. Then, a heat treatment at the temperature of 130° C. was applied for 1.5 minutes. Finally, the washing fastness of the garters was determined in accordance with the protocol ISO 105-C06.

To test the washing fastness, various filament samples were stitched on the modified polyester textile, such as normal polyester, nylon, and cotton. After the test, the color fastness of the filament samples stitched on the modified polyester textile was measured by a standard color fastness instrument to determine if the dye of the modified polyester textile would come off or being transferred to the filament samples. In sunlight fastness test, the dyed garters were irradiated with a sun-like light source in accordance with the protocol, ISO 105-B02, and the color fastness was determined by the standard color fastness instrument. The washing fastness level of each of the normal polyester, nylon, and cotton was 4.0, whereas the sunlight fastness level of the modified polyester was 4.0.

### EXAMPLE K2

The operating condition was generally the same as example K1 except for the dyeing temperature, which was 110° C. The hue whiteness (L) and the relative color strength were 18.9 and 121, respectively. The washing fastness level of each of the normal polyester, nylon, and cotton was 4.0, whereas the sunlight fastness level of the modified polyester was 4.0.

### EXAMPLE K3

The operating condition was generally the same as example K1 except for the dyeing temperature, which was 120° C. The hue whiteness (L) and the relative color strength were 18.6 and 128, respectively. The washing fastness level of each of the normal polyester, nylon, and cotton was 4.0, whereas the sunlight fastness level of the modified polyester was 4.0.

### EXAMPLE K4

The operating condition was generally the same as example K1 except for the dyeing temperature, which was 130° C. The hue whiteness (L) and the relative color strength were 18.0 and 121, respectively. The washing fastness level of each of the normal polyester, nylon, and cotton was 4.0, whereas the sunlight fastness level of the modified polyester was 4.0.

### EXAMPLE L (COMPARATIVE EXAMPLE)

The operating condition was generally the same as example K1 except for the concentration of CSS-910, which was 100 wt %. The hue whiteness (L) was 21.1.

In summary, the modified PET polyester (CSS-910) exhibits lower hue whiteness (L) than the unmodified one at the same dyeing temperature, which is lower than 130° C. Additionally, the relative color strength of the modified PET polyester (CSS-910) is higher than 100, which indicates that the modified polyester may exhibit better dyeing performance than the unmodified polyester (e.g. deeper dyed color) at the same dyeing temperature. The hue whiteness (L) results also confirm that the modified polyester fiber exhibits better dyeing performance. Data is showed in Table 4.

TABLE 4

| | | Dyeing | | |
|---|---|---|---|---|
| | Modifying | temperature | | Relative color |
| Example | agent | (° C.) | L value | strength (%) |
| K1 | with | 100 | 19.8 | 112 |
| K2 | | 110 | 18.9 | 121 |
| K3 | | 120 | 18.6 | 128 |
| K4 | | 130 | 18.0 | 121 |
| L | without | 100 | 21.1 | 100 |

The result confirms that modified polyester when dyed at relatively lower temperature (<130° C.), may comply with the industry application standard, for the washing fastness of each of the normal polyester, nylon and cotton is above level 4. The result also confirms that the modified polyester exhibits relatively higher dyeing strength, and would not fade easily in washing. Additionally, the modified polyester textile also attains level 4 sunlight fastness.

According to one embodiment of the present invention, the polyester mixture may be dyed at a relatively lower temperature (<130° C.). The dyeing property of the modified polyester is still within acceptable range even though it was dyed at a relatively lower temperature (<130° C.). In addition, the modified polyester fiber does no differ significantly in mechanical properties when compared with those of the unmodified polyester fibers. Additionally, the provided dyeable polyesters, which may be dyed at temperature lower than 100° C., may attain the ideal industrial application standard in washing and sunlight fastness tests, and may be mixed spun with nature or artificial fibers to produce various high value filaments.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for dyeing a modified polyester fiber, comprising the steps of:
(a) providing a polyester composition, which is a reaction product of an aromatic dicarboxylic acid and an aliphatic di-ol;
(b) adding a modifying agent to the polyester composition by melt blending to form a thermoplastic composition, wherein the modifying agent is in an amount ranging from about 1 to 16 parts by weight per 100 parts by weight of the thermoplastic composition, and is a aliphatic-aromatic co-polyester and has a structure represented by the following general formula (1): 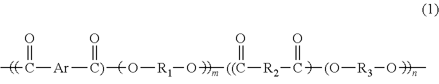
where Ar is a C₆₋C₂₀ aromatic group, each of R₁, R₂ and R₃ is independently a C₂-C₂₀ alkane, each of R₁, R₂ and R₃ may be same or different, 50≦m≦400, 60≦n≦160, and the m/n ratio is a value between about 0.9 and 2.5;
(c) melt spinning the thermoplastic composition to obtain the modified polyester fiber; and
(d) dyeing the modified polyester fiber with a disperse dye at a temperature between about 100° C. and about 130° C.

2. The method of claim 1, wherein the disperse dye is a blue disperse dye.

3. The method of claim 1, wherein the modifying agent is in an amount ranging from about 3 to 12 parts by weight per 100 parts by weight of the thermoplastic composition.

4. The method of claim 1, wherein the modifying agent has a melting point between about 100° C. to 200° C.

5. The method of claim 1, wherein the aliphatic-aromatic co-polyester is a reaction product of at least one aliphatic dicarboxylic acid, at least one aromatic dicarboxylic acidm and at least one aliphatic di-ol.

6. The method of claim 5, wherein the aliphatic dicarboxylic acid is selected from the group consisting of malonic acid, succinic acid, glutaric acid, adipic acid, pimelic acid, suberic acid, azelaic acid, sebacic acid, maleic acid, fumaric acid, 2,2-dimethyl glutaric acid, 1,3-cyclopantane dicarboxylic acid, 1,4-cyclopantane dicarboxylic acid, 1,3-cyclohexane dicarboxylic acid, diglycolic acid, itaconic acid, and 2,5-norbornane dicarboxylic acid.

7. The method of claim 5, wherein the aromatic dicarboxylic acid is selected from the group consisting of terephthalic acid, phthalic acid, 2,6-naphthalene dicarboxylic acid, and 1,5- naphthalene dicarboxylic acid.

8. The method of claim 5, wherein the aliphatic di-ol is selected from the group consisting of ethylene glycol, 1,2- propylene glycol, 1,3- propylene glycol, diethylene glycol, 2,2-dimethyl-1,3- propylene glycol, 1,3-butylene glycol, 1,4-butylene glycol, 1,5- pentylene glycol, 1,6- hexylene glycol, 2,2,4-trimethyl-1,6-hexylene glycol, 1,3- cyclohexanedimethanol, and 1,4-cyclohexanedimethanol.

9. The method of claim 5, wherein the polyester composition comprises polyethylene terephthalate.

10. A method for dyeing a blended fabric, comprising the steps of:
(a) providing a polyester composition, which is a reaction product of an aromatic dicarboxylic acid and an aliphatic di-ol;
(b) adding a modifying agent to the polyester composition by melt blending to form a thermoplastic composition, wherein the modifying agent is in an amount ranging from about 1 to 16 parts by weight per 100 parts by weight of the thermoplastic composition, and is a aliphatic-aromatic co-polyester and has a structure represented by the following general formula (1): 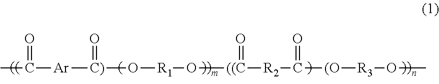
where Ar is a C₆-C₂₀ aromatic group, each of R₁, R₂ and R₃ is independently a C₂-C₂₀ alkane, each of R₁, R₂ and R₃ may be same or different, 50≦m≦400, 60≦n≦160, and the m/n ratio is a value between about 0.9 and 2.5;
(c) melt spinning the thermoplastic composition to obtain a modified polyester fiber;
(d) blend weaving the modified polyester fiber with a fiber to obtain the blended fabric, wherein the fiber does not tolerate a temperature higher than 130° C.; and
(e) dyeing the blended fabric with a disperse dye at a temperature between about 100° C. and about 130° C.

11. The method of claim 10, wherein the modifying agent has a melting point between about 100° C. to 200° C.

12. The method of claim 10, wherein the aliphatic-aromatic co-polyester is a reaction product of at least one aliphatic dicarboxylic acid, at least one aromatic dicarboxylic acidm and at least one aliphatic di-ol.

13. The method of claim 12, wherein the aliphatic dicarboxylic acid is selected from the group consisting of malonic acid, succinic acid, glutaric acid, adipic acid, pimelic acid, suberic acid, azelaic acid, sebacic acid, maleic acid, fumaric acid, 2,2-dimethyl glutaric acid, 1,3-cyclopantane dicarboxylic acid, 1,4-cyclopantane dicarboxylic acid, 1,3-cyclohexane dicarboxylic acid, diglycolic acid, itaconic acid, and 2,5-norbornane dicarboxylic acid; the aromatic dicarboxylic acid is selected from the group consisting of terephthalic acid, phthalic acid, 2,6-naphthalene dicarboxylic acid, and 1,5- naphthalene dicarboxylic acid; and the aliphatic di-ol is selected from the group consisting of ethylene glycol, 1,2- propylene glycol, 1,3- propylene glycol, diethylene glycol, 2,2-dimethyl-1,3- propylene glycol, 1,3-butylene glycol, 1,4-butylene glycol, 1,5-pentylene glycol, 1,6- hexylene glycol, 2,2,4-trimethyl-1,6-hexylene glycol, 1,3-cyclohexanedimethanol, and 1,4- cyclohexanedimethanol.

14. The method of claim 10, wherein the polyester composition comprises polyethylene terephthalate.

15. The method of claim 10, wherein the fiber that does not tolerate a temperature higher than 130° C. is cotton, wool, linen, silk or nylon.

16. A low-temperature dyeable polyester fiber, produced from a thermoplastic composition comprising polypropylene terephthalate and a modifying agent, wherein the modifying agent is in an amount ranging from about 1 to 16 parts by weight per 100 parts by weight of the thermoplastic composition, and is a aliphatic-aromatic co-polyester and has a structure represented by the following general formula (1): 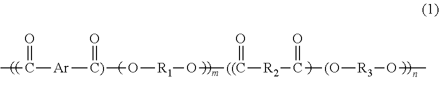
where Ar is a C₆-C₂₀ aromatic group, each of R₁, R₂ and R₃ is independently a C₂-C₂₀ alkane, each of R₁, R₂ and R₃ may be same or different, 50≦m≦400, 60≦n≦160, and the m/n ratio is a value between about 0.9 and 2.5, whereby the low-temperature dyeable polyester fiber can be dyed at a temperature between about 100° C. and about 130° C.

17. The low-temperature dyeable polyester fiber of claim 16, wherein the modifying agent has a melting point between about 100° C. to 200° C.

18. The low-temperature dyeable polyester fiber of claim 16, wherein the aliphatic-aromatic co-polyester is a reaction product of at least one aliphatic dicarboxylic acid, at least one aromatic dicarboxylic acidm and at least one aliphatic di-ol.

19. The low-temperature dyeable polyester fiber of claim 18, wherein the aliphatic dicarboxylic acid is selected from the group consisting of malonic acid, succinic acid, glutaric acid, adipic acid, pimelic acid, suberic acid, azelaic acid, sebacic acid, maleic acid, fumaric acid, 2,2-dimethyl glutaric acid, 1,3-cyclopantane dicarboxylic acid, 1,4-cyclopantane dicarboxylic acid, 1,3-cyclohexane dicarboxylic acid, diglycolic acid, itaconic acid, and 2,5-norbornane dicarboxylic acid; the aromatic dicarboxylic acid is selected from the group consisting of terephthalic acid, phthalic acid, 2,6-naphthalene dicarboxylic acid, and 1,5- naphthalene dicarboxylic acid; and the aliphatic di-ol is selected from the group consisting of ethylene glycol, 1,2- propylene glycol, 1,3- propylene glycol, diethylene glycol, 2,2-dimethyl-1,3- propylene glycol, 1,3-butylene glycol, 1,4-butylene glycol, 1,5- pentylene glycol, 1,6- hexylene glycol, 2,2,4-trimethyl-1,6-hexylene glycol, 1,3- cyclohexanedimethanol, and 1,4- cyclohexanedimethanol.

20. The low-temperature dyeable polyester fiber of claim 16, wherein the low-temperature dyeable polyester fiber is further blend weaved with a fiber that does not tolerate a temperature higher than 130 ° C. to obtain a low-temperature dyeable blending fabric, whereby the low-temperature dyeable blending fabric can be dyed at a temperature between about 100° C. and about 130° C.
